(19) United States
(12) Patent Application Publication
(10) Pub. No.: US 2007/0121161 A1
(43) Pub. Date: May 31, 2007

(54) Image-Processing Device

(75) Inventor: Akihiro Yamada, Nagoya-shi, Aichi-ken (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/565,163

(22) Filed: Nov. 30, 2006

(30) Foreign Application Priority Data
Nov. 30, 2005 (JP) 2005-345727

(51) Int. Cl. G06K 15/00

(52) U.S. Cl. 358/1.16; 358/1.13

(57) ABSTRACT

An image-processing device performs a job related to an image processing, having a storage unit, a control unit, and a display unit. The storage unit stores data generated by the job. The storage unit having a storage memory capacity. The control unit determines whether the storage memory capacity is insufficient for processing a new job, while a current job is in process. The control unit restricts the new job if the storage memory capacity is insufficient for processing the new job. The display unit displays memory usage status of the storage unit and a memory requirement to process the new job.

### CROSS REFERENCE TO RELATED APPLICATIONS

This application claims priority from Japanese Patent Application No. 2005-345727 filed Nov. 30, 2005. The entire content of each of these priority applications is incorporated herein by reference.

### TECHNICAL FIELD

The present invention relates to an image-processing device such as a printer, a scanner, a copier, and facsimile machine.

### BACKGROUND OF THE INVENTION

When stoppages or delays in printing processes occur with laser printers or other image-processing devices, the user must gain a clear understanding of the reasons for such stoppages and delays in order to take the appropriate measures quickly. For this reason, Japanese patent application publication Hei 9-034752 discloses a device in which displays data indicating the occurrence of a shortage of memory and the required memory capacity on a display unit of the host computer when a memory shortage occurs during data entry or a printing operation.

As a process to deal with insufficient memory occurring during data entry, the image-forming device disclosed cannot record subsequent forms when the memory becomes full during form entry, but displays the memory size for the forms that could not be entered and prompts the user to determine whether to draw out or delete the forms that were entered. As a process for dealing with insufficient memory during printing, the image-processing device counts the number of times that the image resolution is reduced due to insufficient memory when generating an object for one page worth based on the received data, saves data for the amount of memory required to print the remaining objects at the prescribed resolution as an average amount of needed memory and a maximum amount of needed memory, and continues printing. If the number of reductions in resolution exceeds a prescribed threshold, the image-processing device displays data indicating the insufficient memory, and the average amount of needed memory and maximum amount of needed memory stored in memory, and prompts the user to expand the memory.

However, the image-processing device described above cannot predict that the memory will become full prior to executing a job. Therefore, the image-processing device must perform processes that are inconvenient for the user when the memory becomes full, such as deleting already entered forms and automatically reducing resolution for printing operations, even when the user wishes to print in a high resolution.

Further, the image-processing device described above merely determines whether a memory shortage occurs when executing a single job, such as form entry or printing. This is problematic for the image-processing device comprising a plurality of functions, such as a printer function, facsimile function, copier function, and scanner function, that manages data used in jobs for each function with a single memory since the facsimile device cannot clearly determine the status of memory usage when jobs for a plurality of functions are processed simultaneously.

### SUMMARY OF THE INVENTION

In view of the foregoing, it is an object of the present invention to provide a image-processing device capable of clearly determining the status of memory usage before a new job starts processing while a current job is in process, and capable of predicting when a shortage in memory will occur prior to executing a new job.

The invention provides an image-processing device for performing a job related to an image processing, having: a storage unit, a control unit, and a display unit The storage unit stores data generated by the job. The storage unit having a storage memory capacity. The control unit determines whether the storage memory capacity is insufficient for processing a new job, while a current job is in process. The control unit restricts the new job if the storage memory capacity is insufficient for processing the new job. The display unit displays memory usage status of the storage unit and a memory requirement to process the new job.

The invention provides an image-processing device performing a job related to an image processing, having a display unit. The display unit displays a memory usage status, a memory requirement to process a new job, a needed memory capacity for the new job in memory size, and a menu prompting a user to select whether to actually free up an occupied memory.

The invention provides a method for controlling an image-processing device for performing a job related to an image processing. The image-processing device has a storage unit that stores data generated by the job. The method includes determining whether the storage unit is insufficient for processing a new job, while a current job is in process; restricting the new job until it is determined that the storage unit becomes not-insufficient for processing the new job; and releasing the restriction on the new job when the storage unit becomes not-insufficient for processing the new job.

The invention provides a method for controlling an image-processing device for performing a job related to an image processing. The method includes displaying a memory status and a memory requirement to process a new job, while a current job is in process; determining whether a part of a memory can be freed up; and prompting a user to select whether to actually free up a memory

### BRIEF DESCRIPTION OF THE DRAWINGS

Illustrative aspects in accordance with the invention will be described in detail with reference to the following figures wherein:

FIG. 1 is a perspective view showing a multifunction device according to the invention;

FIG. 2 is a side cross-sectional view of the multifunction device;

FIG. 3 is a perspective view of the multifunction device 1 with a scanning unit being open;

FIG. 4 is a block diagram showing details of a controller for the multifunction device;

FIGS. 5A-5D show displays on a liquid crystal display (LCD) indicating memory status of a shared area of a RAM in the controller;

FIG. 6 is a flowchart illustrating steps for showing current memory status prior to a new job;

FIG. 7 is a flowchart illustrating steps for processing the new job;

FIG. 8 shows a message displayed on the LCD prompting the user to select whether to cancel the new job;

FIG. 9 shows a message indicating current memory status; and

FIG. 10 shows a diagram illustrating the current memory status, using a bar graph.

### DETAILED DESCRIPTION

An image-processing device according to some aspects of the invention will be described while referring to the accompanying drawings wherein like parts and components are designated by the same reference numerals to avoid duplicating description. The expressions “front”, “rear”, “above”, “below”, “right”, and “left” are used throughout the description to define the various parts when the multifunction device is disposed in an orientation in which it is intended to be used.

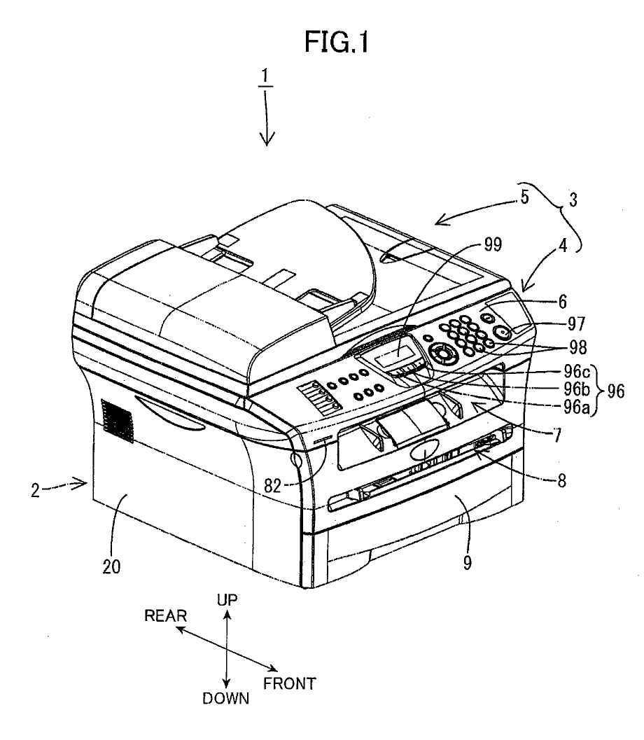

Referring to FIG. 1, a multifunction device 1 as the image-processing device has a printer function, a scanner function, a copier function, and a facsimile function to process a job performed by any one of the above functions. In this description, a job is a task to process a group of data such as an image by using one of the printing, scanner, copier, and facsimile functions as an image processing.

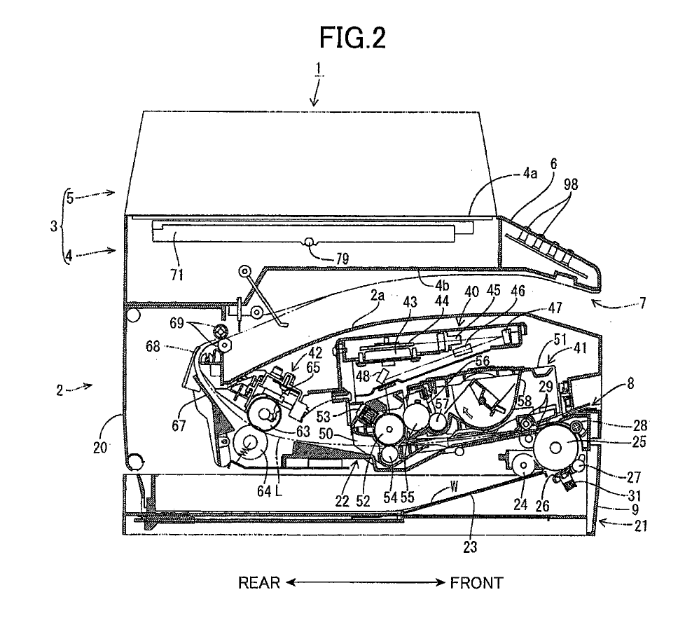

As shown in FIG. 2, the multifunction device 1 includes an image-forming unit 2 accommodating a feeding section 21 and an image-forming section 22; a scanning unit 3 with an automatic document feeder 5; and a controller 10 for controlling the image-forming unit 2 and the scanning unit 3.

The image-forming unit 2 has a casing 20 for accommodating the feeding section 21 for feeding a sheet of paper W and the image-forming section 22 for forming an image on the paper W fed by the feeding section 21. A discharge tray 2a is provided above the image-forming section 22 for maintaining sheets of the paper W that have been discharged from the image-forming section 22.

The feeding section 21 includes a paper cassette 9, a paper-pressing plate 23 disposed inside the paper cassette 9, a pickup roller 24 disposed above the front edge of the paper cassette 9, a feeding roller 25, a separating pad 26, a pinch roller 27 disposed in opposition to the feeding roller 25, a paper dust roller 28, and registration rollers 29 disposed downstream of the paper dust roller 28 with respect to a conveying direction for conveying the paper W.

The separating pad 26 is disposed in confrontation with the feeding roller 25. A spring 31 is disposed on the underside of the separating pad 26 to press the separating pad 26 to the feeding roller 25.

The image-forming section 22 includes a scanning unit 40, a process unit 41, and a fixing unit 42.

The scanning unit 40 is disposed in an upper section of the casing 20 and includes a laser light-emitting unit (not shown), a polygon mirror 44 that is rotatably disposed, a polygon motor 43 for driving the polygon mirror 44 to rotate, lenses 45 and 46, and reflecting mirrors 47 and 48. The laser light-emitting unit emits a laser beam based on image data. The laser beam is reflected by the mirror 44, passes through the lens 45, is reflected by the mirror 47, passes through the lens 46, and is reflected by the mirror 48 in turn. The laser beam is irradiated in a high-speed scan over the surface of a photosensitive drum 52 in a process unit 41.

The process unit 41 is detachably mounted in the casing 20. The process unit 41 includes a drum cartridge 50 and a developer cartridge 51.

The drum cartridge 50 includes the photosensitive drum 52, a Scorotron charger 53, and a transfer roller 54. The developer cartridge 51 includes a developing roller 55, a thickness-regulating blade 56 for contacting the developing roller 55 with pressure, a toner-supplying roller 57, and a toner box 58 filled with toner.

A fixing unit 42 is disposed downstream of the process unit 41 in the paper-conveying direction (rearward). The fixing unit 42 includes a heating roller 63 for generating heat to fuse the toner on the paper surface, a pressure roller 64 for pressing the paper against the heating roller 63, and a thermostat 65.

In the fixing unit 42, toner transferred onto the paper W in the process unit 41 is fixed by heat generated by the heating roller 63 and a pressure provided by the pressure roller 64, as the paper W passes between the heating roller 63 and the pressure roller 64.

After the fixing process, the paper W is conveyed along a discharge path leading to the discharge tray 2a. The discharge path is formed by guide members 67 and 68. A pair of discharge rollers 69 is disposed at the top of the discharge path for discharging the paper W received from the fixing unit 42 onto the discharge tray 2a.

A paper retrieval opening 7 is formed in a lower part of the front panel of the casing 20. The paper retrieval opening 7 is in communication with a discharge tray 2a. A manual feed opening 8 is formed in the image-forming unit 2 below the paper retrieval opening 7 as a slit-shaped opening extending horizontally. A paper cassette 9 is provided below the manual feed opening 8. The paper cassette 9 can be detachably mounted in the image-forming unit 2 through the same side of the multifunction device 1 on which the control panel 6 is provided.

The scanning unit 3 includes an image-reading device 4 having an original support 4a on the top surface thereof, and the automatic document feeder (ADF) 5 arranged so as to cover the original support 4a.

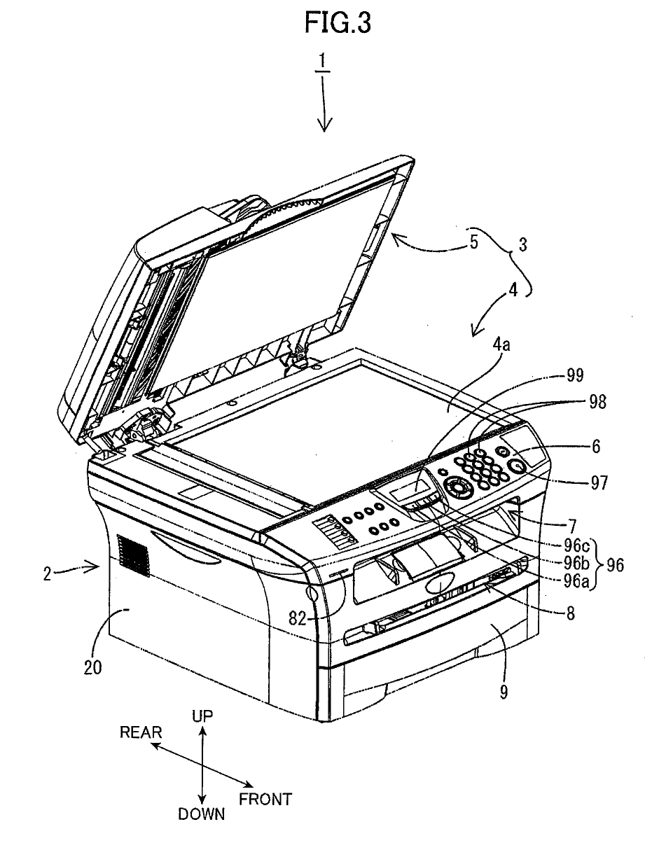

As shown in FIG. 3, the rear edge of the scanning unit 3 is rotatably supported on the top rear edge of the casing 20 so that the scanning unit 3 is capable of rotating on the image-forming unit 2.

The scanning unit 3 scans an original M placed on the document support 4a or conveyed with the ADF 5. After the original M is placed on the document support 4a, a contact image sensor (CIS) 71 moves under the document support 4a along a shaft 79 extending in the conveying direction of the original M in order to scan the original M on the document support 4a one line at a time. When using the ADF 5, the CIS 71 is moved to the left edge of the document support 4a. With staying at the above position, the CIS 71 scans the original M one line at a time while the original M is conveyed by the ADF 5.

Referring to FIG. 1 again, the controller 10 has a control panel 6 provided on a front panel of the casing 20. The user can select an operation by means of the control panel 6. The control panel 6 includes a mode switch 96, a Start key 97, various operating buttons 98, and a liquid crystal display (LCD) 99.

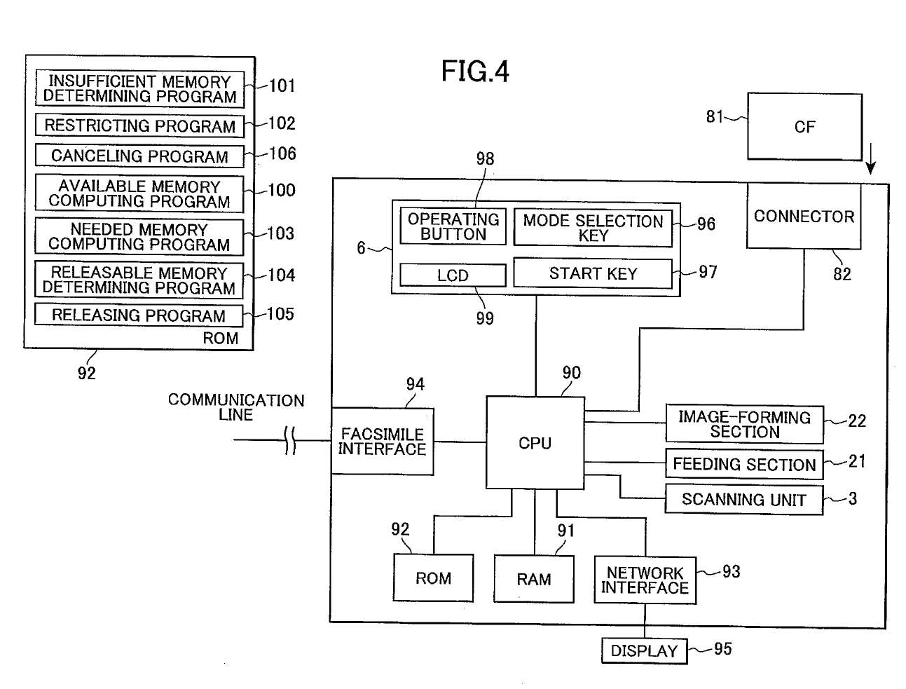

The mode switch 96 enables the user to select from among the modes: a printer mode, a scanner mode, a copier mode, and a the facsimile mode. More specifically, the mode switch 96 includes three mode keys juxtaposed left to right. The three mode keys are a copier key 96a for selecting the copier mode, a facsimile key 96b for selecting the facsimile mode, and a scanner key 96c for selecting the scanner mode. The printer mode is generally selected by a computer 95 connected to the multifunction device 1 (See FIG. 4).

The Start key 97 enables the user to initiate an operation corresponding to the mode which has been selected by the user. For example, if the Start key 97 is pressed (turned on) in the copy mode, the multifunction device 1 starts coping an original document placed on the document support 4a or conveyed by the ADF 5. If the Start key 97 is pressed in the fax mode or scanner mode, the multifunction device 1 starts reading the original.

The LCD 99 displays the status of a shared area in a RAM 91 provided in the controller 10 (see FIG. 4), according to data generated during an operation performed by the multifunction device 1. The LCD 99 displays a message indicating that memory capacity is insufficient, when the shared area does not have sufficient space for storing data to be generated by a new job. The LCD 99 also displays various settings established during prescribed operations.

Next, a detailed structure of the controller 10 will be described with reference to FIG. 4.

As shown in FIG. 4, the controller 10 includes the control panel 6 to accept instructions from the user; the scanning unit 3 for reading image data; the image-forming section 22 and feeding section 21 for forming images on the paper W; a CPU 90; the RAM 91; a ROM 92; a network interface 93 for connecting to the personal computer 95; a facsimile interface 94 for connecting to a telephone line or other communications circuit; and a connector 82 for connecting with a memory card 81 such as a CompactFlash card®. The CPU 90 is electrically connected to the control panel 6, the scanning unit 3, the image-forming section 22, the feeding section 21, the RAM 91, the ROM 92, the network interface 93, the facsimile interface 94, the connector 82. The RAM 91 and the ROM 92 constitute a storage device for the controller 10. The network interface 93 is used to connect to the PC 95. The facsimile interface 94 is used for transferring image by means of the facsimile function.

The RAM 91 has a shared area for storing data generated by the job. The shared area is used for temporarily storing scanned data, received facsimile data, or data to be printed. The shared area of the RAM 91 has a limited capacity for storing data. Accordingly, when a new job needs more capacity to store data than a currently-available memory capacity, the user can restrict data from being stored in the RAM 91, delete unnecessary data, release a part of the shared area of the RAM 91, and reduce the data resolution.

The ROM 92 stores several programs enabling the CPU 90 to implement different operations. In this embodiment, the ROM 92 stores seven programs: a free memory computing program 100; an insufficient memory determining program 101; a restricting program 102; a needed memory computing program 103; a releasable memory determining program 104; a releasing program 105; and a canceling program 106.

The free memory computing program 100 is for calculating the capacity of free memory (Free) in the shared area which is not occupied in order to store data generated by the currently operating job.

The insufficient memory determining program 101 is for determining whether the capacity of available memory in the shared area of the RAM 91 (Available) is insufficient to store data generated by a new job to be executed soon (hereinafter referred to as “newly generated data”).

The restricting program 102 is for restricting on the execution of the new job when it is determined that the capacity of available memory in the shared area for storing the newly generated data is insufficient.

The needed memory computing program 103 is for calculating the required capacity of memory (Needed) to store the newly generated data in the shared area, when the execution of the new job is restricted.

The releasable memory determining program 104 is for determining whether deallocating the currently occupied capacity of the shared area can allocate the sufficient capacity of available memory for storing the newly generated data.

The releasing program 105 is for deallocating a shared area that is releasable.

The canceling program 106 is for removing the restriction on storing the newly generated data in the shared area, when the capacity of available memory in the shared area is sufficient for storing the newly generated data.

The ROM 92 also stores programs for controlling operations of the image-forming unit 2, the scanning unit 3, and the facsimile interface 94; and a program enabling the CPU 90 to store printing formats and print job information in the RAM 91.

Each time the CPU 90 detects that the Start key 97 has been pressed, the CPU 90 begins a procedure for processing a new job, in accordance with the programs stored in the ROM 91.

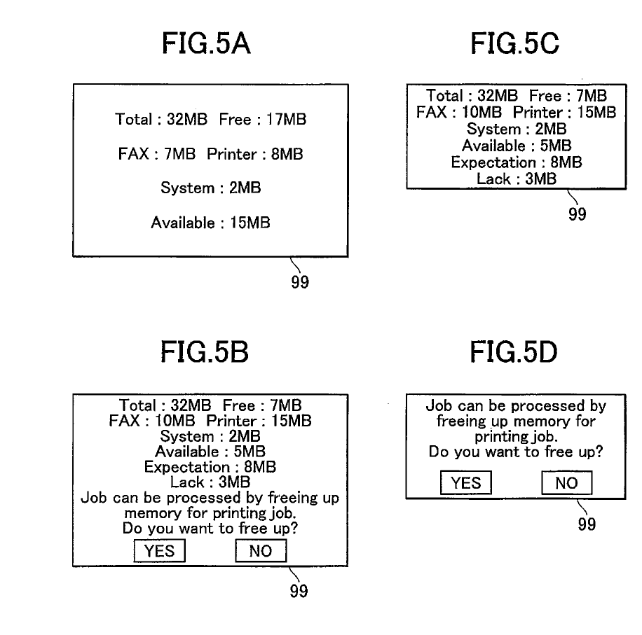

The control panel 6 displays memory status on the LCD 99 as well as various settings for printing. More specifically, as shown in FIG. 5B, the LCD 99 displays the total capacity of memory (Total), the current capacity of free memory (Free), the currently-occupied capacity of memory by the current job (Fax, Printer), the capacity of available memory for storing the newly generated data (Available), the capacity of expected memory required for storing the newly generated data (Estimated), and the insufficient capacity of memory required to satisfy the estimated capacity of memory (Needed) in the RAM 91.

According to the releasable memory determining program 104, the CPU 90 performs a procedure to determine which one of the jobs can free up memory in order to partially free up the shared area of the RAM 91 used by the current jobs. As shown in FIG. 5B, the CPU 90 displays a message on the LCD 99, “A new job can be performed by freeing up memory for printing. Do you wish to free up memory for printing? Yes or No,” prompting the user to select whether or not to free up the memory.

When it is not possible to display the above message together with the various memory status on the LCD 99 and prompt the user to select whether or not to free up memory, the LCD 99 first displays the various memory status on the LCD 99, as shown in FIG. 5C. And then, with the user's scrolling the screen downward by the operating buttons 98, the LCD 99 displays the message prompting the user to select whether to free up the memory, as shown in FIG. 5D.

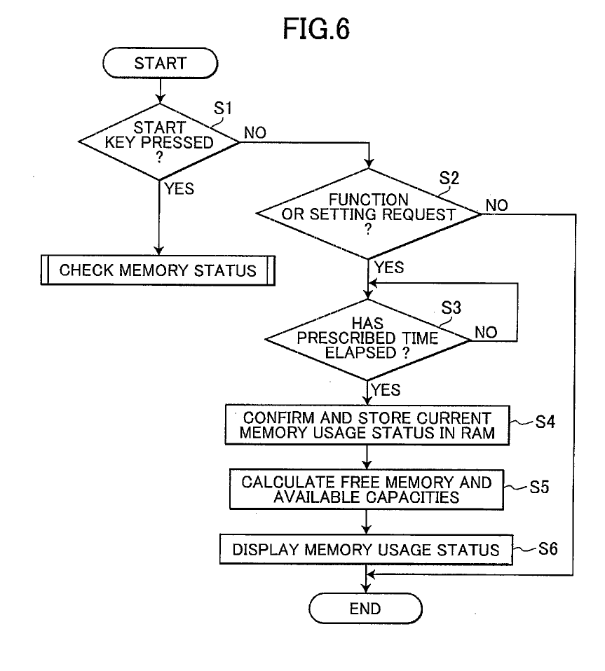

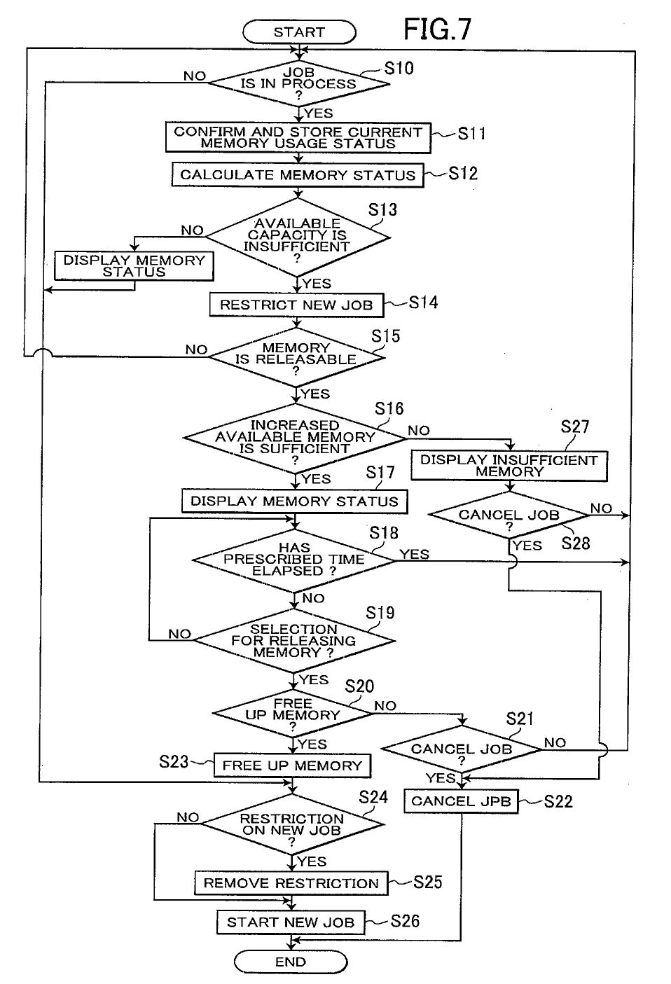

Next, a procedure executed by the CPU 90 will be described with reference to FIGS. 6 through 7.

In S1 of FIG. 6, the CPU 90 determines whether the Start key 97 is pressed to start processing a new job related to one of the facsimile, copier, and scanner functions. The press of the Start key 97 means that the multifunction device 1 has received a new job to be processed. If the CPU 90 determines that the Start key 97 has not been pressed (S1: no), then in S2 the CPU 90 determines whether the user has entered an instruction to select one of the modes or to set the printing format using the mode switches 96. If the CPU 90 determines that the user has entered the instruction to select a mode or set the printing format (S2: yes), then in S3 the CPU 90 activates a timer (not shown) and determines whether a prescribed time has elapsed since the user entered the instruction or set the printing format.

If the CPU 90 determines that the prescribed time has elapsed (S3: yes), then in S4 the CPU 90 determines the memory usage status for the shared area of the RAM 91 and stores data in the RAM 91 indicating the total memory size (total), the amount of memory used by the current job (fax, printer, scanner, copier), and the amount of free memory (free) regardless of whether the multifunction device 1 is processing a job. After executing the process in S4, in S5 the CPU 90 executes the free memory computing program 100 to subtract the total amount of memory used by the current job from the total memory size (Total) to calculate the amount of free memory (Free). The CPU 90 further calculates the amount of available memory (Available) by subtracting the amount of memory required by the operating system (System) from this free memory (3). In S6 the CPU 90 displays on the LCD 99 the various memory status stored in the RAM 91 and the calculated amount of free memory (Free) and available memory (Available). FIG. 5A shows an example of such a display on the LCD 99.

On the other hand, in S2, if the CPU 90 determines that the user has not entered the instruction to select the mode or set the printing format (S2: no), then the CPU 90 ends the procedure and goes back Step S1.

Through the above-described process of S1-S6, the CPU 90 displays on the LCD 99 the usage status for the shared area in the RAM 91 at constant intervals, when the user selects the mode or sets the printing format. Accordingly, even though the usage status of the shared area in the RAM 91 is continually changing according to the data generated by the current job, the multifunction device 1 can display the accurate current-status of memory usage in the shared area by accurately calculating the capacities of free memory and available memory.

When the multifunction device 1 receives an instruction to activate the printing function through the network interface 93 from the computer 95, the CPU 90 then determines that a print job has entered the multifunction device 1 as a new job.

In S1, when the CPU 90 determines that the Start key 97 has been pressed (S1: yes), the CPU 90 then goes to the procedure for determining the capacity of the RAM 91 as shown in FIG. 7. Referring to FIG. 7, in S10, the CPU 90 determines whether at least one job, i.e., a current job is in process. If the CPU 90 determines that at least one job is in process (S10: yes), then in S11 the CPU 90 confirms the memory usage status of the RAM 91, and stores the total memory size (Total) and the capacity of occupied memory by the current job (Facsimile, Printer, Scanner, and Copier) in the RAM 91.

After executing the process of S11, in S12 the CPU 90 calculates the capacities of free memory (Free), available memory (Available), estimated memory usage (Estimated), and estimated memory needed (Needed), based on the current job and the new job. In particular, the capacity of estimated memory usage (Estimated) is calculated, considering the following contributing factors. It should be noted that the free memory capacity (Free) is a memory capacity which has not been occupied or used by the current job. The available memory capacity (Available) is a memory capacity which is available for the new job. The estimated memory usage capacity (Estimated) is a memory capacity which is required for processing the new job. The estimated memory needed (Needed) is a memory capacity which is obtained by subtracting the estimated memory usage capacity from the available memory capacity when available memory capacity is less than the estimated memory usage capacity. Generally, the available memory capacity is less than the free memory capacity, because the free memory capacity may reduce as the current job as the current job proceeds.

When the new job is related to the printer function, the capacity of estimated memory usage is calculated based on the paper size for printing, a resolution of the image to be printed, and printing format (color or monochrome).

When the new job is related to the copier function, the capacity of estimated memory usage is determined based on the paper size, resolution that have been selected by the copy mode key 96a and printing format (color or monochrome).

When the new job is related to the facsimile function, the capacity of estimated memory usage is determined based on the paper size selected by the fax mode key 96b. However, since a recipient of the facsimile transmission does not know in what resolution the data will be sent, it is nearly impossible to accurately determine the estimated capacity of memory usage (Estimated). A great difference might be caused between the estimated capacity of memory usage (Estimated) and the actual capacity of memory usage for the new job, if only the paper size is considered. Therefore, the maximum capacity of memory usage for each paper size is considered as the estimated capacity of memory usage (Estimated).

When the new job is related to the scanner function, the estimated capacity of memory usage (Estimated) is calculated based on the paper size, resolution, and printing format (color or monochrome) selected by the scanner mode key 96c.

In addition to the above-described contributing factors, the CPU 90 stores an average value for the coverage (ratio of the image area to the area of the paper) processed by the current job and an average value for the previous actual capacities of memory usage in the RAM 91, and adds these average values to the requirements for determining the estimated capacity of memory usage (Estimated), thereby calculating the estimated capacity of memory usage (Estimated) which is closer to the actual capacity of memory usage for the new job.

The CPU 90 executes the needed memory computing program 103 to calculate the estimated amount of memory needed (Needed), based on the new job. According to this program, the CPU 90 subtracts the capacity of available memory (Available) from the estimated amount of memory usage (Estimated) to calculate the estimated amount of memory needed (Needed).

After calculating the capacities of free memory (Free), available memory (Available), estimated memory (Estimated), and needed memory (Needed) in S12, in S13 the CPU 90 executes the insufficient memory determining program 101 to compare the capacity of available memory (Available) to the estimated amount of memory usage (Estimated) for the new job and then determine whether the available memory is insufficient for the new job. If the CPU 90 determines that the available memory is insufficient (S13: yes), then in S14 the CPU 90 executes the restricting program 102 to restrict on the execution of the new job (Available).

After executing the process in S14, in S15 the CPU 90 executes the releasable memory determining program 104 to determine whether it is possible to clear a part of the RAM 91 occupied by the current job to increase the capacity of available memory (Available). If the CPU 90 determines that it is possible to clear the part of the RAM occupied by the current job (S15, yes), then in S16, the CPU 90 predicts the estimated-increasing capacity of available memory and determines whether the estimated-increasing capacity of available memory is sufficient for storing the newly generated data. If the CPU 90 determines that the estimated increasing capacity of available memory is sufficient for storing the newly generated data (S16, yes), then in S17, the CPU 90 displays the memory capacities stored in the RAM 91 in S11, the memory capacities calculated in S12, and a message on the LCD 99 prompting the user to select whether to free up memory determined in S15 to be clearable. FIG. 5B shows an example of the display on the LCD 99.

On the other hand, if the CPU 90 determines that the available memory is sufficient to accept the newly generated data (S13: no) then in S18 the CPU 90 displays on the LCD 99 the memory capacities stored in the RAM 91 in S11 and the memory capacities calculated in S12. In this case, the capacity of needed memory (Needed) calculated according to the needed memory computing program 103 is equal to or less than 0, and the capacity of available memory (Available) exceeds the estimated amount of memory usage (Estimated). Accordingly, the CPU 90 may display on the LCD 99 “Needed: ***” or “Available memory is sufficient” in place of the “Needed: 3 MB” in the example display of FIG. 5C, or may simply not display the capacity of needed memory (Needed).

After executing the process in S17, in S18 the CPU 90 determines whether the prescribed time has elapsed since S17 by using a timer (not shown). If the CPU 90 determines that the prescribed time has not elapsed (S18: no), then in S19 the CPU 90 determines whether the user has made a selection as to whether to free up memory. If the user has not made a selection, that is, if the CPU 90 determines that neither the “Yes” button nor the “No” button have been selected in the display shown in FIG. 5B or FIG. 5D (S19: no), then the CPU 90 returns to S18 and determines whether the prescribed time has elapsed. If the CPU 90 determines that the prescribed time has elapsed (S18: yes), then the CPU 90 returns to S10 to determine whether at least one job is in process

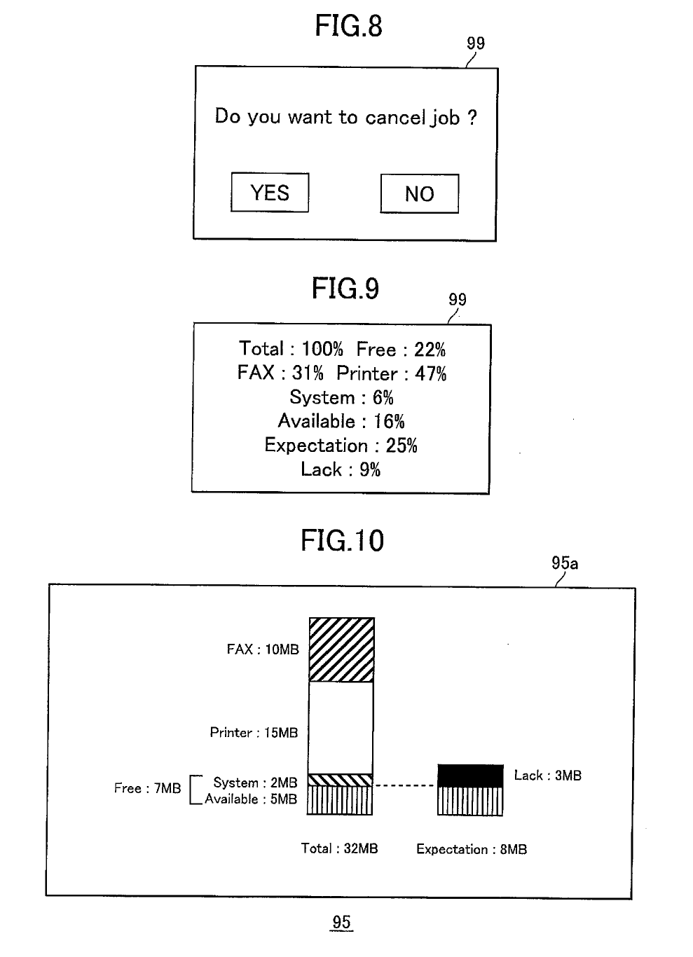

In S19, if the user has made a selection (S19: yes), then in S20 the CPU 90 determines whether the user has selected to free up the memory. If the user has selected to not free up the memory, that is, if the “No” button has been selected in the display shown in FIG. 5B or FIG. 5D (S20: no), then in S21 the CPU 90 allows the current job to continue and displays the message “Cancel job? Yes No” shown in FIG. 8, prompting the user to select whether to cancel the new job. If the user selects the “Yes” button (S21: yes), then in S22 the CPU 90 cancels the new job and quits the process. However, if the user selects the “No” button (S21: no), then the CPU 90 returns to S10 and determines whether at least one current job is in process.

However, if the user has selected the “Yes” button in the display of FIG. 5B or FIG. 5D, indicating a desire to free up the memory (S20: yes), then in S23 the CPU 90 executes the releasing program 105 to free up the memory area which is designated to be freed up. After freeing up the designated memory area, in S24 the CPU 90 determines whether a restriction has been placed on the new job by the restricting program 102. If the CPU 90 determines that the new job has been restricted due to the insufficient available memory (S24: yes), then in S25 the CPU 90 executes the canceling program 106 to remove the restriction on the new job. After removing the restriction in S25, the CPU 90 starts implementing the new job and stores the newly generated data into the RAM 91 in S26. And then, the CPU 90 quits the current procedure.

If the CPU 90 determines that no restriction has been placed on the new job (Available; S24: no), then the CPU 90 skips the process of S25, and initiates implementing the new job in S26, and quits the current procedure.

If the CPU 90 determines in S16 that the increased capacity of available memory is not sufficient for storing the newly generated data (S16, no), then in S27, the CPU 90 displays on LCD 99 a message indicating that the available memory is insufficient, showing that “Not available for new job due to insufficient memory.” Then in S28, the CPU 90 allows the current job to continue and displays the message “Cancel job? Yes No” shown in FIG. 8, prompting the user to select whether to cancel the new job. If the user selects the “Yes” button (S28: yes), then in S22 the CPU 90 cancels the new job and quits the process. On the other hand, if the user selects the “No” button (S28: no), then the CPU 90 returns to S10 and determines whether at least one current job is in process.

In S15, if the CPU 90 determines that it is not possible to clear the part of occupied the part of the RAM occupied by the current job (S16, no), then the process returns to S10.

Specific methods for freeing up (allocating) a portion of the shared area in the RAM 91 in the procedure shown in FIG. 7 include printing out facsimile data stored in the RAM 91 and then deleting the printed facsimile date from the RAM 91; reducing scanning resolution; reducing a scanning speed; expanding the memory; and deleting data having no relation with the current job.

By printing out received facsimile data, the received facsimile data generated through the facsimile function and stored in the RAM 91 can be deleted from the RAM 91 after printing, thereby increasing the available memory in the RAM 91.

When the amount of data generated by the scanner function with the normal resolution of the scanning unit 3 exceeds the capacity of available memory in the RAM 91, it is possible to reduce the amount of data to an extent of storing in the available memory of the RAM 91 by reducing the scanning resolution.

Further, the scanning buffer used for the scanner function can be reduced by slowing the scanning speed, thereby reducing the amount of image data supplied to the RAM 91 per unit time.

By connecting an external memory 81 such as the CompactFlash card 81® to the connector 82, it is possible to increase the total memory size (Total) of the shared area in the RAM 91. Accordingly, even when the amount of newly generated data being processed exceeds the capacity of available memory (Available), the processed data by the new job can be saved in the external memory.

When the newly generated data exceeds the available memory size (Available), data having a relatively low level of importance may be deleted from the shared area in the RAM 91 in order to store the newly generated data.

Similarly, if the memory becomes completely occupied after the execution of the new job, the CPU 90 may display the usage status of the shared area in the RAM 91, along with a message prompting the user to determine if memory can be freed up and to select whether to free up the memory. In this case, the CPU 90 accurately determines the actual capacity of memory required by the new job, rather than the estimated capacity. Accordingly, the CPU 90 more accurately displays the usage status of the shared area, and accurately determines what areas of memory can be cleared.

While the invention has been described in detail with reference to the above aspects thereof, it would be apparent to those skilled in the art that many modifications and variations may be made therein without departing from the spirit of the invention, the scope of which is defined by the attached claims.

For example, the following variation falls within the technical scope of the present invention.

(1) When processing the new job, it is possible to calculate the amount of needed memory for each of various printing formats, such as N-in-1 printing, multiple copies, high-speed printing emphasizing processing speed, low-memory operation emphasizing the conservation of usage in the shared area, thereby making it possible to select a printing format that does not result in insufficient memory.

(2) The method of calculating the needed amount of memory (Needed) may involve subtracting the amount of available memory (Available) from the estimated amount of memory (Estimated) needed for the newly generated data, or may involve subtracting the total memory size (Total) from the total of the estimated capacity of required memory (Estimated), the capacity of memory used by each current job (Fax, Printer, Scanner, and Copier), and the capacity of memory required by the operating system (System).

(3) Each memory status displayed on the CPU 99 may be represented by a percentage (%) of the total memory area in the RAM 91, as shown in FIG. 9.

(4) It is possible to issue a beep sound when in addition to displaying the capacity of needed memory (Needed) on the LCD 99 when the memory is full.

(5) A display 95a of the personal computer 95 connected to the multifunction device 1 via a network may display the memory status of the multifunction device 1 (see FIG. 10). The usage status of the RAM 91 may be displayed as shown in FIG. 10, since the display 95a of the personal computer 95 is generally larger than the LCD 99 and displays images in multiple colors.

The multifunction device of the invention can gauge whether a data process by the new job can be performed prior to actually executing the new job. If the multifunction device determines that the new job cannot be executed due to insufficient available memory, the controller 10 restricts the execution of the new job.

Further, since the multifunction device displays the capacity of needed memory and the capacity of the storage area used by the current job which is in process, the multifunction device can clearly determine the usage status of the storage area and can quickly take appropriate measures.

The multifunction device of the invention can determine the usage status of the storage area in more detail, including which functions are using the storage area and how much of the storage area the functions are using.

Even when there is insufficient capacity in the storage area and the multifunction device restricts on the new job, the multifunction device can remove this restriction on the new job if the current job subsequently ends and there is no longer a memory shortage. Therefore, as soon as a memory shortage is resolved, the multifunction device can initiate a data process according to the new job.

Since the multifunction device of the invention can accurately calculate the available capacity in the storage area, the multifunction device can more accurately determine whether the capacity in the storage area is insufficient to perform a new job.

The multifunction device of the invention can accurately calculate available capacity, even though the status of the storage area used by the current job is constantly changing.

The multifunction device of the invention can more accurately estimate the capacity required for storing data generated by a new functional operation.

The multifunction device of the invention enables the user to quickly understand the usage state of the storage area visually.

The multifunction device of the invention enables the user to select a job to be performed with priority, thereby improving user friendliness.

What is claimed is:

1. An image-processing device for performing a job related to an image processing, comprising:
a storage unit that stores data generated by the job, the storage unit having a storage memory capacity;
a control unit that determines whether the storage memory capacity is insufficient for processing a new job while a current job is in process, the control unit restricting the new job if the storage memory capacity is insufficient for processing the new job; and
a display unit that displays memory usage status of the storage unit and a memory requirement to process the new job.

2. The image-processing device according to claim 1, wherein the storage memory capacity includes an occupied memory capacity used to process the current job, the control unit subtracts the occupied memory capacity from the storage memory capacity to obtain a free memory capacity which has not been used by the current job, and the control unit calculates an available memory capacity for the new job, based on a type of the current job and the occupied memory capacity.

3. The image-processing device according to claim 1, wherein the image-processing device is a multifunction device to perform at least two of a printer function, a scanner function, a copier function, and a facsimile function as the image processing, the printer function recording the image on a recording medium, the scanner function scanning the image, the copier function copying the image, and the facsimile function faxing the image, the job performing one of the at least two functions.

4. The image-processing device according to claim 1, wherein the control unit releases the restriction on the new job when the storage memory capacity becomes not-insufficient during the restriction of the new job.

5. The image-processing device according to claim 1, wherein the storage memory capacity includes a first memory capacity required to process the current job,
the control unit calculates an available memory capacity for the new job, according to a type of the current job, the first memory capacity, and the storage memory capacity, and wherein
the control unit calculates an estimated memory capacity required to process the new job, and compares the estimated memory capacity to the available memory capacity, thereby determining whether the storage memory capacity is insufficient for processing the new job.

6. The image-processing device according to claim 5, wherein the control unit calculates the available memory capacity at prescribed time intervals while the current job is in process.

7. The image-processing device according to claim 5, wherein the control unit subtracts the estimated memory capacity from the available memory capacity to obtain a needed memory capacity for performing the new job, while the current job is in process.

8. The image-processing device according to claim 7, wherein the control unit calculates the needed memory capacity at prescribed time intervals while the current job is in process.

9. The image-processing device according to claim 1, wherein the display unit displays the memory usage status and the needed memory capacity in memory sizes.

10. The image-processing device according to claim 1, wherein the display unit displays the memory usage status and the needed memory capacity at a ratio therebetween in the storage memory capacity.

11. The image-processing device according to claim 1, wherein the storage unit has a first memory capacity required to process the current job,
the control unit determines whether a part of the first memory capacity can be freed up in order to increase an available memory for the new job when the storage memory capacity is insufficient for processing the new job,
the control unit determines whether the increased available memory is sufficient for processing the new job, when the part of the first memory capacity can be freed up,
the control unit prompts a user to select whether to actually free up the part of the first memory capacity, when the increased available memory is sufficient for processing the new job, and
the control unit frees up the part of the first memory capacity and starts processing the new job, when the actual freeing up the first memory is selected.

12. An image-processing device performing a job related to an image processing, comprising:
a display unit that displays a memory usage status, a memory requirement to process a new job, a needed memory capacity for the new job in memory size, and a menu prompting a user to select whether to actually free up an occupied memory.

13. The image-processing device according to claim 12, wherein the display further displays a total memory size, an available memory size, and an estimated memory size required to process the new job.

14. A method for controlling an image-processing device for performing a job related to an image processing, the image-processing device having a storage unit that stores data generated by the job, comprising:
determining whether the storage unit is insufficient for processing a new job, while a current job is in process;
restricting the new job until it is determined that the storage unit becomes not-insufficient for processing the new job; and
releasing the restriction on the new job when the storage unit becomes not-insufficient for processing the new job.

15. The method according to claim 14, further comprising:
calculating an available memory capacity in the storage unit, and an estimated memory capacity required to process the new job, while the current job is in process;
determining whether the available memory capacity is less than the estimated memory capacity;
restricting the new job when the available memory capacity is less than the estimated memory capacity; and
releasing the restriction on the new job when the available memory capacity becomes more than or equal to the estimated memory capacity.

16. A method for controlling an image-processing device for performing a job related to an image processing, comprising:
displaying a memory status and a memory requirement to process a new job, while a current job is in process;
determining whether a part of a memory can be freed up; and
prompting a user to select whether to actually free up a memory.
